(19) United States
(12) Patent Application Publication
(10) Pub. No.: US 2006/0232828 A1
(43) Pub. Date: Oct. 19, 2006

(54) Millimeter-wave imaging apparatus

(75) Inventor: Neil Anthony Salmon, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 10/550,117

(22) PCT Filed: Mar. 18, 2004
(86) PCT No.: PCT/GB04/01153

§ 371 Date: Sep. 19, 2005

(30) Foreign Application Priority Data
Mar. 22, 2003 (GB) 0306678.4

(51) Int. Cl. H04N 1/40

(52) U.S. Cl. 358/448; 358/511

(57) ABSTRACT

A millimetre wave imaging apparatus comprises a scanning mechanism, a reflector lens and a receiver array. The scanning mechanism comprises two wedge prisms which scan radiation incident upon them across the receiver array in an elliptical pattern. This optical configuration is such that the pupil plane, defined by the scanning mechanism, is located optically at the centre of curvature of the focusing surface, which reduces coma and astigmatism optical aberrations.

This invention relates to an imaging apparatus. More particularly, but not exclusively, it relates to a millimetre wave imaging apparatus.

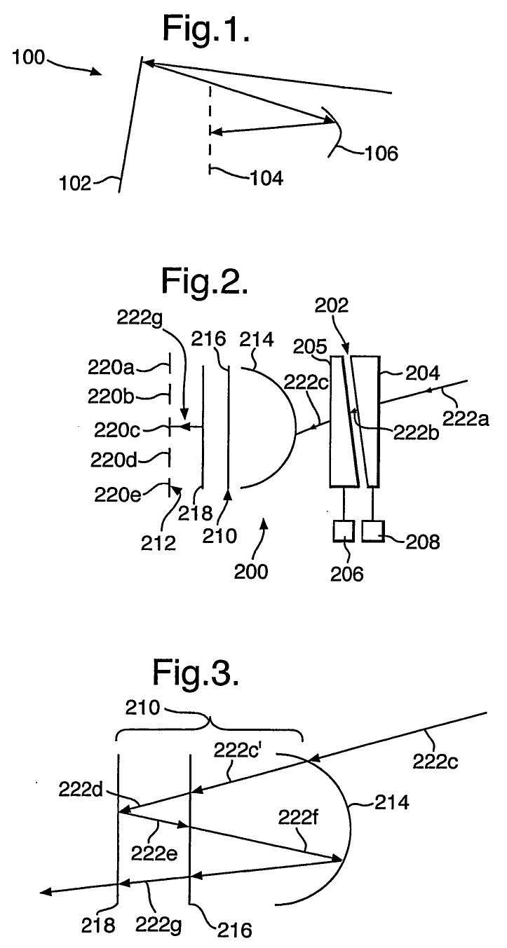

A current real-time passive millimetre wave imager 100, as shown in FIG. 1, typically employs a mechanical scanning device 102 located behind a receiver array 104 to scan a wide field of view onto a focusing reflector 106. The receiver array 104 typically lies in the focal plane of the focusing reflector 106. Increasing the number of elements in an imager's receiver array allows the dwell time on each pixel of an image to be increased during a mechanical scan, thereby increasing the signal to noise ratio for each pixel and increasing image quality. However, due to physical size constraints upon the size of receiver array elements, such an increase in the number of elements causes beam obscuration, due to the geometry of the imager 100.

Another problem associated with current imaging apparatus is that it samples the field of view at a sub-Nyquist rate, typically at less than half Nyquist rate. This is particularly true with staring arrays in which there is no mechanical scanning of the field of view across the focal plane. Sub-Nyquist sampling leads to poor image quality. This is why scanning arrays have hitherto provided better quality images than staring arrays.

According to the present invention there is provided a millimetre wave imaging apparatus comprising scanning means, focusing means and a plurality of receiver elements, the focusing means being physically interposed between the scanning means and the receiver elements, the scanning means being arranged to scan radiation from a field of view onto said focusing means such that focussed radiation from a region of the field of view is incident upon at least one of the plurality of receiver elements.

This architecture allows a large number of elements to be introduced into the focal plane, without causing beam obscuration for a large field of view, as the receiver elements do not lie in the path of radiation passing from the scanning means to the focusing means. This enables higher sensitivities to be achieved than existing mechanical scanning passive millimetre wave imagers.

Additionally, this architecture allows Nyquist sampling and relative calibration to be achieved using a high-density receiver element array. The scanning means may be two prisms. The prisms may be wedge prisms. The prisms may be of uniform thickness and varying refractive index across their respective cross-sections. Each of the prisms may be arranged to rotate. The prisms may be arranged to rotate in opposite directions to each other. The prisms may be arranged to produce an elliptical scan path in the focal plane. The elliptical scan path may have a minor diameter that corresponds approximately to half the array spacing of the elements in an array. This ensures that Nyquist sampling is achieved in the direction of the array. It also results in adjacent elements sampling the same region of a scene alternately, which allows relative calibration of elements to be employed.

The plurality of receiver elements may be arranged in a linear, or a curvilinear array. The prisms may be arranged to rotate at a rate of at least 25 revolutions per second.

The scanning means may be a prism. The prism may be a wedge prism. The prisms may be of uniform thickness and varying refractive index across a cross-section thereof. The prism may be arranged to rotate. The prism may be arranged to produce a circular scan path in the focal plane. The plurality of receiver elements may be arranged in a sparse two dimensional, or a linear array.

An imaging apparatus with a single prism scanning means is cheaper and simpler to manufacture than a dual prism apparatus; as only a single prism and drive means need to be produced.

The focusing means may be a reflector lens. The reflector lens may comprise a first polarising element, typically a wire grid. The reflector lens may further comprise a polarisation altering element, for example a Ferrite or a Faraday plate, typically arranged to alter the polarisation of radiation incident thereupon by about 45°. The reflector lens may also comprise a second polarising element, typically a wire grid, usually arranged to reflect radiation transmitted by the first polarising element. Typically, the radiation incident upon the second polarising element is polarised at 45° to that transmitted by the first polarising element.

Alternatively, the focusing means may be a refractive element or a diffractive element.

The scanning means, which may be arranged to define an entrance pupil of the apparatus, may be placed at the effective centre of curvature of the focusing means.

The invention will now be described, by way of example only, with reference to the accompanying drawings, in which:

FIG. 1 is a millimetre wave imaging apparatus of the prior art;

FIG. 2 is a schematic diagram of a first embodiment of an imaging apparatus according to the present invention;

FIG. 3 is a schematic diagram of a focusing arrangement of the imaging apparatus of FIG. 2;

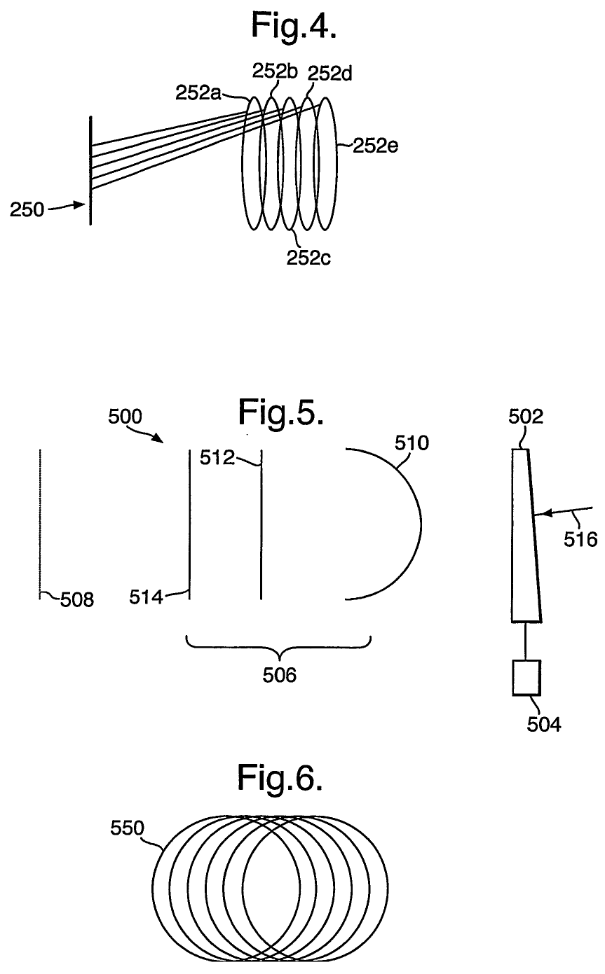

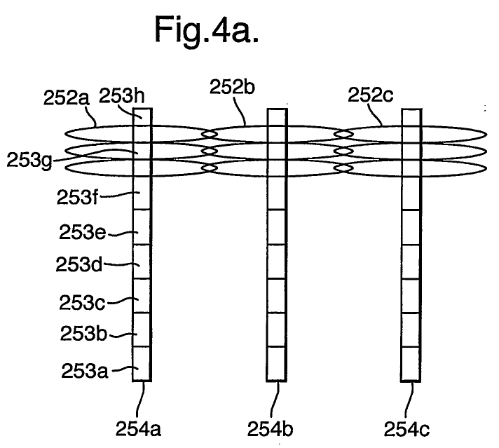

FIG. 4 is a representation of an elliptical scan path produced by the imaging apparatus of FIG. 2;

FIG. 4a is a representation of elliptical scan paths incident upon three linear arrays;

FIG. 5 is a schematic diagram of a second embodiment of an imaging apparatus according to the present invention; and

FIG. 6 is a circular scan path produced by the imaging apparatus of FIG. 5.

Referring now to FIGS. 2 to 4a, a millimetre wave imaging apparatus 200 comprises a scanning mechanism 202, a focusing device 210 and a receiver array 212.

The scanning mechanism 202 comprises first and second disc shaped wedge prisms 204, 205, typically a Risley prism, that are connected to respective drive mechanisms 206, 208. For small beam deviations, typically a few degrees, a low loss wedge shaped piece of refractive index, such as polythene, can be used while for large beam deviations, typically ten degrees or more, a wedge of “Lettington reflector lens” can be used. A “Lettington reflector lens” comprises two linearly polarising grids, having a polarisation difference of 45° therebetween, that are separated by a sheet of Faraday rotator that rotates the polarisation by 45°.

The prisms 204, 205 are connected to respective drive mechanisms 206, 208 such that they counter-rotate (in opposing directions) about their respective centres, typically at more than 25 Hz. The drive mechanisms 206, 208 are arranged to create an elliptical scan pattern. Such an elliptical scan pattern is sufficient to scan a number of linear [symbol] plane.

The focusing device 210 (essentially a reflector lens, also known as a Lettington lens) comprises a first grid 214 typically of metallic wires, typically either horizontally or vertically aligned, a polarisation altering element 216, typically a meanderline structure, Ferrite or a Faraday plate, usually arranged to rotate the polarisation of incident radiation by 45°, and a second grid 218 usually of metallic wires, normally inclined at 45°, to the first grid 214. The scanning mechanism 202 is located optically at the radius of curvature of the first grid 214, by reflection in the grid 218. As the scanner defines the entrance pupil of the imager this arrangement reduces optical aberrations of coma and astigmatism. Physically this means the scanning mechanism 202 is next to the curved grid 214. As the receiver array 212 needs to be in the focal plane of the focusing device 210, these devices are physically adjacent to each other. This means the scanning mechanism 202, the focusing device 210 and the receiver array 212 are physically next to each other, which offers a very compact arrangement.

The receiver array 212 is made up of a plurality of radiometer receiver arrays 220a-e (shown extending into the plane of the paper), each array typically comprising input feedhorns and detector elements. The receiver arrays 220a-e are typically linear or curvilinear and are composed of a plurality of receiver elements.

In use, radiation 222a incident upon the first rotating prism 204 is refracted by an amount that is dependent upon the thickness of the prism 204 at the point at which the radiation 222a impinges upon the prism. As the prism 204 is of variable thickness and is rotating, radiation impinging upon the prism 204 at the same point in space will be subject to a degree of refraction that varies with time. This effect is also achievable by the use of a rotating prism of constant thickness but varying refractive index.

Radiation 222b passes between the first prism 204 and the second prism 205 where it is refracted for a second time, again with a time varying magnitude due to the rotation of the second wedge prism 205.

Radiation 222c impinges upon the first grid 214 of the lens 210 where it is selectively linearly polarised orthogonal to the orientation of the grid 214 to produce radiation 222c′. The polarisation altering element 216 rotates the polarisation of the radiation 222c, typically by 45°, to produce radiation 222d. This radiation 222d is reflected by the second grid 218 such that radiation 222e passes back through the polarisation altering element 216 and has its polarisation rotated further, usually by 45°. Radiation 222f now has a planar polarisation that is parallel to the wires of the first grid 214. This radiation is therefore reflected therefrom back through the polarisation altering element 214 to produce radiation 222g that is polarised perpendicularly the wires of the second grid 218 and can therefore pass through the second grid 218 and is focussed onto the receiver arrays 220a-e.

The result of such an optical arrangement is that a field of view 250 is divided into a number of overlapping elliptical scan paths 252a-e. Scan path 252a is the part of the field of view that is projected, portion by portion, onto a single array element of the array 212 as the prisms 204, 205 rotate.

The minor diameter of the elliptical scan paths 252a-e are typically such that they correspond to half the spacing of linear elements 253a-h of an array 254a-c. This allows adjacent elements 253a-h of a linear array 254a-c to measure the same region of space, thus allowing relative calibration, which improves image quality. Such a sampling also allows Nyquist sampling in the direction of the array 254a-c. This is because to achieve Nyquist sampling in a perfect array sampling is need elements. The only way this can be achieved is by mechanically scanning to sample between the feed locations, the elements. The major diameter of the scan paths 252a-e correspond to the distance between the arrays 254a-c. In this way all regions of space in the field of view are scanned. Furthermore, with the major elliptical diameter corresponding to the array separation, array elements 253a-h of one linear array 254a measure the same region of the image as the adjacent array 254b once per revolution. This overlap can be used for relative calibration, which improves image quality.

The major diameter of the scan paths 252a-e are typically such that regions between the linear arrays 220a-e can be sampled and the wedge angle of the prisms 204, 205 is such that there is overlap between the arrays 220a-e. The relative speed of rotation of the prisms 204, 205 within the imaging apparatus 200 that allows the formation of elliptical scan patterns. This allows Nyquist sampling is the direction perpendicular to the receiver arrays 220a-e and also allows relative calibration of array elements between the receiver arrays 220a-e.

Referring now to FIGS. 5 and 6, an imaging apparatus 500 comprises a wedge prism 502, a drive mechanism 504 for rotating the prism 502, a reflector lens 506 and a receiver array 508.

The reflector lens 506 comprises a first grid 510, typically of wires, a polarisation altering element 512, typically a meanderline, Ferrite or Faraday plate, usually arranged to rotate the polarisation of incident radiation by 45°, and a second grid 514. The reflector lens 506 operates substantially as hereinbefore described with reference to the reflector lens 110 of FIG. 1.

Radiation 516 incident upon the prism 502 undergoes [symbol] magnitude of refraction such that upon passing through [symbol] 506 a circular scan path 550 is traced in a focal plane of the imaging apparatus 500.

Typical receiver array 508 configurations for such an optical arrangement include linear and two-dimensional sparse arrays.

1. A millimetre wave imaging apparatus comprising scanning means, focusing means and a plurality of receiver elements, the focusing means being physically interposed between the scanning means and the receiver elements, the scanning means comprising two rotatable prisms arranged to scan radiation from a field of view onto said focusing means such that focussed radiation from a region of the field of view is incident upon at least one of the plurality of receiver elements.

2. (canceled)

3. Apparatus according to claim 1 wherein each prism is a wedge prism.

4. Apparatus according to claim 2 wherein each prism is of uniform thickness and varying refractive index across a cross-section thereof.

5. (canceled)

6. Apparatus according to claim 1 wherein the scanning means is arranged to produce a circular scan path in the focal plane.

7-8. (canceled)

9. An apparatus according to claim 1 wherein the prisms are arranged to rotate in opposite directions to each other.

10. An apparatus according to claim 1 wherein the prisms are arranged to produce an elliptical scan path in the focal plane.

11. An apparatus according to claim 10 wherein the elliptical scan path has a minor diameter that approximately corresponds to a spacing between adjacent receiver element of an array.

12. An apparatus according to claim 10 wherein the plurality of receivers are formed into a two dimensional array, and the elliptical scan path has a major diameter that approximately corresponds to a distance between adjacent receiver elements of an array.

13. An apparatus according to claims 1 wherein the prisms are arranged to rotate at a rate of at least 25 revolutions per second.

14. An apparatus according to claim 1 wherein the plurality of receiver elements are arranged in a linear array, a curvilinear array or a sparse two dimensional array.

15. An apparatus according to claim 1 wherein the focusing means is a reflector lens.

16. An apparatus according to claim 15 wherein the reflector lens comprises a first polarising element.

17. An apparatus according to claim 15 wherein the reflector lens comprises a second polarising element arranged to reflect radiation transmitted by the first polarising element.

18. An apparatus according to of claim 15 wherein the reflector lens comprises a polarisation altering element.

19. Apparatus according to claim 1 wherein the scanning means, which is arranged to define an entrance pupil of the apparatus, is placed at the effective centre of curvature of the focusing means.
